(19) United States
(12) Patent Application Publication
(10) Pub. No.: US 2006/0248035 A1
(43) Pub. Date: Nov. 2, 2006

(54) System and method for search advertising

(76) Inventors: Sam Gendler, Santa Barbara, CA (US); John Ellis, Westlake Village, CA (US); Steve Chang, Los Vegas, NV (US); Darren J. Davis, Los Angeles, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/116,933

(22) Filed: Apr. 27, 2005

(51) Int. Cl. G06F 17/30

(52) U.S. Cl. 707/1

(57) ABSTRACT

A system and method of optimizing pay-for-placement advertising is disclosed. The disclosed method includes the selection of a metric for evaluating the performance of a pay-for-placement advertisement or “listing,” and predicting the performance of the listing relative to said metric using a particular search term at a plurality of positions on a plurality of search engines. The method further includes predicting the anticipated cost and effectiveness for each position, search engine combination, and the setting of new bids or retention of old bids for listings based on said predictions. The disclosed method includes the use of historical data regarding the effectiveness of a particular listing or search term to predict future performance at different listing positions or on different search engines or contextual advertising services. The party placing the advertising can then compare the effectiveness of a listing across different search engines or contextual advertising services in order to optimize its advertising campaigns.

### BACKGROUND OF THE INVENTION

1. Field of the Invention

The present invention relates to methods of Internet advertising and is specifically directed to a method of optimizing online pay-for-placement advertising.

2. Background

Computer networks, particularly the Internet, provide an increasingly important medium for advertising all types of goods and services. Currently, the Internet extends to millions of computers in more than a hundred countries. The Internet includes the World Wide Web (the “Web”), whereby a huge number of “Web servers” connected to the Internet disseminate via “web pages” various types of information or content, including text, graphics, and media (video and audio) files. Typically, web pages are viewed on computers using “web browser” software, such as the “Internet Explorer” distributed by Microsoft Corp. However, web pages may also be accessed by other devices, such as personal digital assistants (“PDA's), mobile phones, etc.

Various technological developments have given rise to tremendous growth in use of the Internet generally, and the Web in particular. These developments include the increased availability of both commercial and residential high-speed Internet connections, improvements in the capabilities of browser and server software, improvements in search services that allow users to quickly identify sources of useful information, and the dramatic increase in the amount of information that is available. The broad acceptance of the Web as a tool for research, communication, recreation, and commerce has attracted vast numbers of users, such that nearly all businesses have some type of “presence” on the Web. As businesses have embraced the Web as a tool for selling products, the capability to provide secure payment and ordering systems has also been developed. As a result, a large and vibrant Web-based marketplace has emerged.

The unique features of the Web provide a platform for a variety of different forms of advertising. Initially, advertising on the Web primarily took the form of display advertisements, similar to traditional advertising seen in print media and on television, and this mode of advertising remains important. Web page operators sell space for display advertisements of various configurations such as “banner” and “sidebar” advertisements of various shapes and sizes. The ability of web browsers to open multiple display windows on a computer screen has also led to the creation of variations such as “pop-up” and “pop-under” advertisements that open in a new window either on top of or underneath the window displaying the Web page itself. New types of display advertisements are constantly being developed and tested.

Recently, a new form of Web advertising has developed to exploit the capabilities of the various search engines that allow users to find Web sites of interest. Because of the vast number or websites on the Internet, search engines play a critical role in enabling users to find websites of interest. Typically, there are two modes of directly accessing a search engine: (1) the user navigates to a search engine website and enters a “query” in a format that the particular search engine is capable of recognizing, or (2) using a browser “plug-in,” such as an add-on “toolbar,” or a built in browser setting, the user may directly enter a query, and the browser directly accesses the search engine without first navigating to and displaying the search engine website. In either case, the search engine processes the query and returns search results, typically in the form of listings of web sites which are known to the search engine and which meet the search criteria. Search engines also deliver context sensitive text ad listings through affiliate websites. These listings are intended to appear with content that is contextually relevant to the listings, based on the keywords selected by the advertiser or other criteria.

The listings returned in either instance, referred to herein as “listings” or “search listings,” typically includes “links” to the sites, such that each of the listed sites can be accessed by “clicking” on the link. Unless the search terms are very narrow, the results of a search may include an extremely large number of search results or “hits”. Thus, for example, a recent search for the term “United Airlines” on the popular “Google” search engine website, produced over two million listings, and a search on the “Yahoo” website of the relatively uncommon surname “Schnapf” produced over 4,500 listings. Accordingly, most search engines use some type of algorithm to sort the search results in order of relevance. The order or position in which the listings are presented is very important to users who rarely have the time or patience to sift through a very large number of search results.

A rapidly emerging and highly profitable trend is for search engines to allow advertisers to control the position of their listing within the results of a Web user's search. The specific placement of an advertiser's listing may be based on the search words selected by the user, the amount the advertiser is willing to pay for favorable placement, or a combination of these and other factors. This new form of advertising is sometimes referred to as paid placement, search engine marketing or search engine advertising. One example of such a system is described in U.S. Pat. No. 6,269,361 System and Method for Influencing a Position on a Search Result List Generated by a Computer Network Search Engine.

As the number of search engines which provide paid placement and the number of advertisers using such services have increased, the search engine advertising marketplace has become more complicated. Differences in the popularity of the various search engines are reflected in different pricing for placed listings, and different search engines appeal to different users. As a result it is increasingly difficult for advertisers to develop strategies to efficiently and effectively use this mode of advertising. Current methods and systems for managing search advertising campaigns fail to provide for dynamic, effective, highly automated optimization of search advertising campaigns in the current search advertising marketplace.

### SUMMARY OF INVENTION

The present invention is directed to meeting the need for dynamic, flexible, highly automated tools for optimizing search advertising campaigns. In one embodiment, the present invention constructs a sorted list of every term or group of terms in a campaign on every selected search engine at every possible bid position. The list is sorted on the same metric to which the campaign will be optimized. It then pulls items from this sorted list to establish a collection of listings, bids, and positions to be set on those search engines. It then sets those items until the campaign budget is exhausted or until the optimization threshold is achieved.

It is an object of the present invention to provide a method and system for optimizing search advertising campaigns across multiple pay-for-placement advertising mechanisms. It is a further object of the present invention to provide a method and system for optimizing search advertising campaigns across single or multiple search engines or other providers of paid placement advertising. It is a further object of this invention to provide a method and system for optimizing search advertising campaigns to any metric relevant to the campaign manager, and to any campaign budget regardless of how it is priced. It is a further object of this invention to provide a method and system for allowing advertising campaigns to be priced flexibly using a variety of different pricing mechanisms, including without limitation cost-per-click, cost-per-response, percentage of revenue, etc. It is further object of the present invention to provide a method and system that gives advertisers far greater flexibility and control in managing their search advertising campaigns.

### BRIEF DESCRIPTION OF THE DRAWINGS

FIG. 1 shows the results of a search on a commonly used search engine that provides for paid or sponsored search listings.

FIG. 2 is a chart illustrating the term landscape for the term “dog food” on a hypothetical search engine.

FIG. 3 is a chart illustrating a sorted list of term landscape entries used to optimize a search advertising campaign.

FIG. 4 is a group of charts illustrating four hypothetical term landscape entries at various positions on various search engines for the term “dog food.”

FIG. 5 is a bar chart showing hypothetical normalized changes in click volume between listing positions on two search engines.

FIG. 6 is a table showing historical click data for a single listing.

FIG. 7 is a table showing weighted averages of historical click data for a single listing.

FIG. 8 is a table showing three hypothetical term landscape entries.

### DETAILED DESCRIPTION OF THE PREFERRED EMBODIMENTS

Methods and systems for managing and optimizing search advertising campaigns are disclosed. The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the preferred embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

Search engines generally allow users to enter a request or query consisting of a search term, or a group of search terms, in order to find information related to such terms. Normally there are a variety of search terms that are available to advertisers to connect with potential buyers. This is true not only where an advertiser sells multiple products, but also because many products have a variety of synonymous names, any of which might be employed in a user's search. Thus, a user might select car, automobile, SUV, minivan, pickup, station wagon, coupe, etc., and the advertiser may want to include all of these terms in its advertising strategy.

Search terms can also include location information to provide for location specific search capabilities. In addition, different search engines use different matching algorithms, ranging from “exact” matching to broader matching. In “exact” matching systems, a listing will only be displayed if the search term selected by an advertiser exactly matches (including the spelling and word order) of the search query provided by a consumer. Broader matching systems may display listings in response to searches using the same words but in different order, or using only subsets of the search term. As used herein a “term” or “search term” refer to both the singular and plural, and may consist of a single term, a group of terms, or even multiple groups of terms that make up a search request or query in accordance with the usage of a particular search engine, and which may be matched either exactly or more broadly in accordance with the applicable rules for the subject search engine.

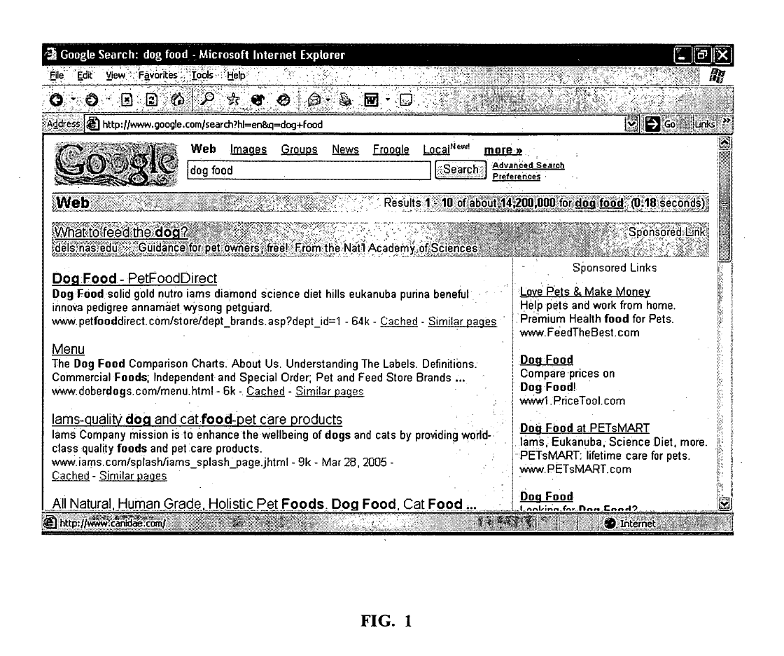

As shown in FIG. 1, search results currently produced by search engines in response to a user query 100 generally consist of two distinct types of search listings: (1) organic or unpaid listings 101; and (2) paid or sponsored listings 102. One or both of these groups of listings may be presented to the user on their computer screen in some form such that each listing has a particular position or ranking within the results. This may take the form of a numbered list, or the ranking may simply be reflected in the specific placement of the listings on the screen. For consistency, the term “position” will be used herein to describe the position or ranking that determines placement of the listing on the user's screen. While most search engines differentiate generic and sponsored listings when presenting search results, this differentiation is not necessary for purposes of the present invention.

Paid search results are commonly referred to as “search listings” or “listings.” In their current form, listings generally include a small amount of identifying or descriptive text 103 accompanied by a hyperlink to a web site 104. However, there is no inherent limitation on the form of listings. Thus it is anticipated that “listings” will take a variety of forms in the future, including without limitation forms that incorporate graphical images as a component of the listing. As used herein, the term “search listing” or “listing” refers to the results that are displayed to the user, regardless of their specific form.

The position of a particular listing within paid or sponsored listings may be determined by a variety of factors, including but not limited to the click-through-rate or other data points relating to the listing, but the most significant factor is often the amount paid by the advertiser. The search engine operator may set a fixed amount for placing an advertiser in a particular position in response to a specific search term, or may dynamically set the amount by auctioning the traffic derived from searches on specific terms, on a click-by-click basis, to the highest bidder. In either case, in most current search advertising systems, the amount that advertisers actually pay for each consumer response is based on the position of the listing among the search results from a given provider. Accordingly, in bid systems the advertiser bids an amount that it is willing to pay for each consumer response to its listing, where that listing is displayed in response to a search query containing the particular term on which the advertiser had bid.

Generally, because higher positions generate more consumer responses, a higher bid will result in a higher position in the paid or sponsored results presented to the user. However, some search engines determine the position of sponsored listings based on a variety of factors. Normally, search engines will only include a limited number of paid search listings in response to a query, such that the number of positions that can be purchased is relatively small.

Typically, in current systems, the desired consumer action in response to a listing is for the user to “click” on a hyperlink that takes the consumer to the advertiser's web site. Since the purchaser only pays for the listing if a consumer actually clicks on its hyperlink, such systems are said to function on a “cost-per-click” basis, where the “cost-per-click” is the fee (whether bid or fixed) charged to the purchaser each time a consumer clicks on its hyperlink.

While current search engines sell search advertising on a cost-per-click basis, it will be appreciated that many advertisers may prefer to purchase advertising on a different basis. Thus, third parties currently manage advertising campaigns for advertisers, purchasing search advertising from search engines on a cost-per-click basis but billing the actual advertising on a different basis such as the number of specified responses that are received by the advertiser, or the number of revenue events generated for the advertiser. Since these campaign managers are purchasing search advertising on one basis and selling it on a different basis, it is critical that they have a highly flexible and effective method and system for optimizing search advertising campaigns using a variety of performance metrics. For ease of reference, the entity purchasing search advertising shall be referred to herein as the “advertiser,” although it will be appreciated that it may be a campaign manager or another third party that is not the entity whose product or service is actually advertised.

It will also be appreciated that measurable responses other than “clicks” may be taken in response to a search listing. For example, the response taken may depend on the particular device and network that is being used, such that a mobile phone user might search for restaurants in a locale, and the search results might include a listing of phone numbers. The mobile phone service provider can then determine if one of the listed numbers is called in response to the listing. As these new forms of response are deployed, campaign managers will have even more options for pricing campaigns.

Thus, this advertising model is not limited to responses that are made by “clicking” on a hyperlink displayed on a computer screen in response to a search listing, and the basis for pricing can be referred to generally as “cost-per-response” to refer to any consumer action in response to a listing that is of interest or value to an advertiser.

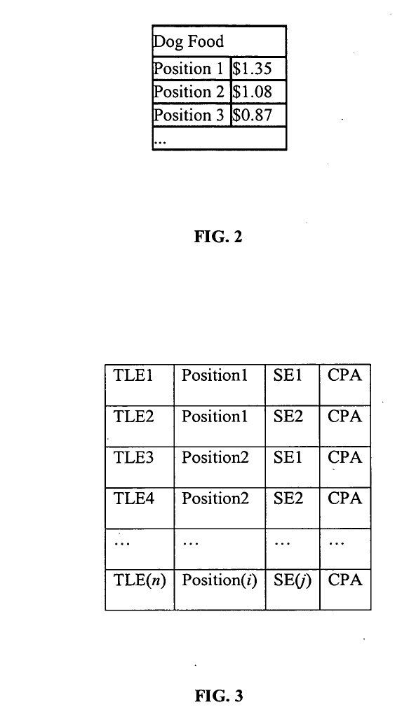

Because search listings vary in cost and effectiveness depending on the term and the search engine, each search term on each search engine has a unique market value. The cost of a listing placed in various positions within the results for a specific term on a specific search engine at a particular time is referred to herein as the “term landscape.” FIG. 2 shows the term landscape for the term “dog food” on a hypothetical search engine at a given time, where the bid for position 1 is $1.35 201, the bid for position 2 is $1.08 202 and the bid for position 3 is $0.87 203. This indicates that the current bid for the listing displayed in position 1 is $1.35. In typical search engine implementations where paid search listings appear, the advertiser would be required to bid at least $0.01 higher than this current bid or $1.36 in order to place a new listing in position 1.

A similar term landscape can be generated for every available term on the search engine. A broader market among all of the relevant search engines also exists for many terms. The collection of different “term landscapes” for the various search engines is referred to herein as the “bid landscape” for a particular term.

The data tracking and gathering capabilities of the Internet also provide unique opportunities to advertisers, who can use these capabilities to identify the specific timing and placement of an advertisement or listing that led to a particular contact with the advertiser's Web site or to a particular purchase, subscription, sales lead or other user response. There are a variety of methods for performing such data tracking and gathering that are known to those skilled in the art, including the use of various types of web beacons and cookies.

Results attributable to a particular search listing can be measured using a variety of different measures, referred to in the industry as metrics. The most commonly used metrics for search engine advertising are the “click-through-rate” and the cost-per-click. Cost-per-click has been described above. Click-through-rate is generally calculated as the percentage of user impressions that result in clicks for a single listing. The click-through-rate for a listing is generally related to the position of that listing in the search results. Where the number of user impressions cannot be determined, an alternative metric referred to herein as the “click rate” may be used. The click rate is the actual number of clicks received over a period of time, rather than as a percentage of impressions. The click rate is expressed as a number of clicks per unit of time, such as the number of clicks per day.

Based on these metrics, the advertiser can continually evaluate its bids for a term in view of the contemporaneous bid landscapes in an effort to optimize an advertising campaign across a plurality of search engines to achieve a specific result. As used herein, the terms “optimize” and “optimization” refer to ongoing efforts to find the best allocation of resources for a particular advertising campaign at a given time for a given data set, recognizing that true “optimum” performance may change over time. For example, some advertisers are not concerned with the number of clicks, but rather the number of specific desired responses that result from such clicks (such as subscriptions or leads). Such an advertiser may increase its bid for a term on a particular search engine and thus increase its cost-per-click, if it determines that the increased traffic resulting from a higher position will actually decrease the overall cost-per-response. This cycle of evaluation and revision can be done repeatedly to optimize the campaign to any available metric over time.

Optimizing a search advertising campaign based on specific metrics in a complex advertising campaign is a formidable task. For example, the advertiser may wish to use multiple search listings with variations in content and/or presentation, or may choose to bid on multiple terms or groups of terms. The advertiser will want to allocate its advertising budget to obtain the best possible results. Any optimization process should identify under performing terms and choose the best terms and listings to meet the campaign goals. The present invention provides a method and system for optimizing advertising campaigns using paid placement on one or more search engines. Results can be optimized for a campaign across single or multiple search engines using one or more search terms, and can be optimized to any measurable metric that is relevant to the advertiser or campaign manager. The inputs to the optimization algorithm will first be described, followed by the optimization process itself.

The present invention uses an initial prediction of the performance relative to a selected metric of a given term for a particular combination of: (1) position within results; and (2) search engine. This calculation yields a performance metric that is a function of the combination of term, listing position, search engine, cost per click, conversion rate, and click rate prediction. For clarity, this performance metric will be referred to generally as a term landscape entry. Thus, the term landscape entry is a selected metric useful in determining the relative value of an advertising expenditure.

Common currently used statistical measures or metrics used to evaluate the performance of a search advertisement include: (1) cost-per-click; (2) cost-per-response; (3) click-through-rate; (4) return on investment; and (5) conversion rate. Other metrics are available, and as data gathering capabilities improve, additional performance metrics will become available.

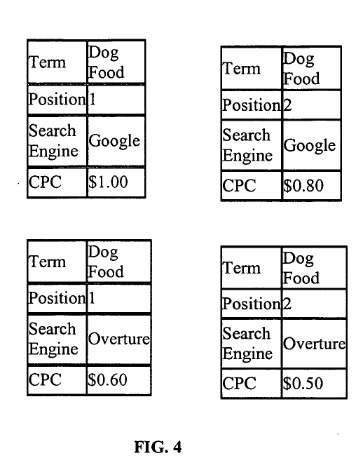

Term landscape entries can be calculated for any relevant metric, including without limitation click-through-rate, cost-per-response, cost-per-click, etc. For example, term landscape entries for a particular search term may appear as illustrated in FIG. 3, where TLE is the term landscape entry, Position(i) is the listing position returned in the sponsored or paid results, and where SE(j) is a particular search engine. Using cost-per-click as the performance measure for the search term “dog food” could result in term landscape entries as illustrated in FIG. 4.

The term landscape entry reflects the performance of a specific term at a specific position on a specific search engine for a specific time period. It will be seen by those skilled in the art, that a term landscape entry could be devised to measure performance against a variety of different metrics, and to incorporate additional considerations. For example, this illustrative example is not specific to a particular search listing. Since the search listing itself can significantly impact performance, it may be useful in some circumstances to establish a term landscape entry that is specific to a particular search listing. In the preferred embodiment, a group or matrix of term landscape entries is generated for each term in a campaign, reflecting the anticipated performance of that term, in each available position, on each available search engine.

In accordance with an aspect of the present invention, a model is used to predict the value of a listing at any position for which there is insufficient experimental data for a particular listing on each search engine. For example, a model which allows the prediction of the click rate at each position on each search engine based on experimental data for a subset of the available positions would be referred to as the “click model” for a listing. It will be apparent to those skilled in the art that a predictive model can be built for any performance measure, with varying degrees of accuracy, based on experimental data about a subset of the overall performance of a listing.

The click model uses historical data about how many clicks were received for a search listing at a particular position or positions over a particular time period to predict how many clicks will be received at any available position in the future. While the current discussion refers to the use of historical data, it is not necessary that all available historical data be used. Rather, some historical data may be disregarded because it is considered to be unreliable, for example, because it is out of date, or because it is merely cumulative to other available historical data. As used herein, the term historical data is intended to include any subset of the available historical data, and further include the concept of giving different available data different weight. Thus, for example, very recent data may be weighed more heavily that older data. Additionally, data from one search engine could be used to model another, particularly if information about the differences in performance between the two search engines is known.

The ability to predict the click rate at any position with reasonable accuracy is predicated on the existence of sufficient reliable historical data regarding the click rate. Where there is no available data, the model is turned off until sufficient data is obtained to begin modeling. In accordance with the present invention, search listings that have some click rate data but are immature or lacking in sufficient specific click rate data are “bootstrapped” using the available limited or generic data. Since the model is using limited or lower quality data, operation of the click model in the “bootstrap” mode will generally provide a less accurate prediction of click rate. The click model of the present invention preferably transitions out of the bootstrap mode and into normal operation once sufficient relevant click rate data is obtained.

The click model of this preferred embodiment assumes that there is a relatively consistent shape to the distribution curve of clicks, based on position. Different search listings will modify the general distribution curve by scaling it on both the X axis (position) and the Y axis (click rate), depending on the relevance of the particular search listing to the term. However, by initially assuming a general distribution curve, the click model can apply known historical click data about a particular term/position/search engine combination to a table of values for the general distribution curve in order to estimate the predicted click volume at all positions for that term/search engine combination for which we have no historical data.

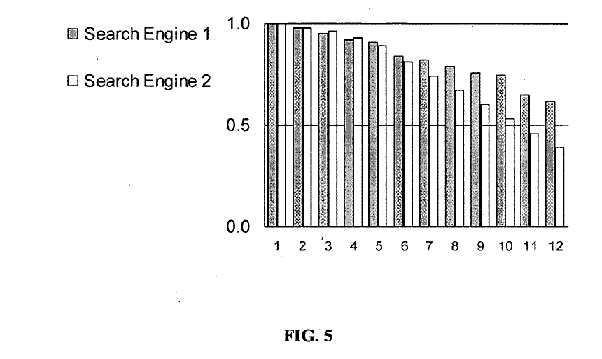

The click model initially assumes that there is a general distribution of clicks which varies by position. As shown in FIG. 5, the click model assumes that this curve represents the normalized (between 1 and 0) change in click volume between position 1 and the maximum position being modeled (maxpos) for the relevant search engine. Using this normalized analysis, if the average change between position one (1) and position two (2) is to decrease click rate by 5%, then position one will be at 1.0 and position two will be at 0.95.

This general distribution curve can be updated regularly to assure that it represents current traffic patterns as accurately as possible. The simplest mechanism for doing so would be to periodically calculate the change in click volume between positions for every term/position/search engine for which there is available historical data. Additionally, there are a variety of statistical techniques well understood in the art that can be used to smooth the general distribution curve. For example, it is possible to calculate the change not just between one position and the position directly above it, but to average the change between one position and several others. Additionally, terms with relatively low click volumes might have dramatically different changes in click volume as compared to terms with much higher click volumes, so the curve used by the modeler might be a collection of curves chosen based upon other performance metrics for a term. It should be noted that once a particular advertising campaign is mature, a distribution curve can be constructed based purely on data specific to that campaign. Such a particularized distribution curve will more accurately predict responses for that campaign.

Once a general distribution curve has been normalized, the click model maps available historical click rate data for a particular listing and term onto the curve to make predictions about behavior at positions for which there is no actual data. Historical click rate data is generally available in two forms. First, search engines currently deliver at least a daily summary for each term which generally provides data indicating average position, average cost per click, and total number of clicks. Some search engines provide more detailed information, including the specific number of clicks for each position rather than just averages.

Second, tracking hosts or other devices provide real-time raw click data including but not limited to: (1) time of click, (2) term, (3) search engine, (4) maximum bid set at the time of the click, and (5) expected position of the listing given the bid that is set. This raw click data can be used to generate information matching that provided by the search engines, aggregated over any time period (daily, hourly, etc). In bootstrap mode, the click model uses raw click data aggregated hourly over a configurable time period. In normal mode, it uses search engine daily aggregates over a longer, but still configurable time period. This longer configurable time period provides an equal number of data points for each day of the week for each term landscape entry. It will be appreciated that any time period can be selected that achieves an appropriate balance between timeliness and the need for a substantial data set that is valid over time.

Using either source of data, the click model creates a two-dimensional array of data points, where each point on the x-axis represents a single time slice. Each point on the y-axis represents a bid position, and the value at any (x, y) location is the number of clicks received at that bid position during that time slice. Since the average position is usually a decimal value rather than a whole number, the click model must compensate for an average position value which is between two actual positions.

The mapping of historical click data to the general distribution curve requires the click model to use certain assumptions. For example, since most search engines provide only average position information, it is generally not known how much time was spent at a particular position. To account for this, the click model of the preferred embodiment splits the time equally between the two relevant positions, which are the two whole numbers nearest to the average position. For example, if the average position for a twenty-four hour period was 2.4, the click model will assume that half of the time the position was at the floor position of 2 and half the time the position was ceiling position of 3. It will be appreciated that more accurate position models may be developed that account for patterns in time, such as using intra-day data to develop a frequency distribution chart that can be used to predict the number of clicks at a particular position on an hourly basis.

In order to determine how many clicks to assign to the floor position of 2 and how many clicks to assign to the ceiling position of 3, the preferred embodiment also assumes that the normalized click rate distribution curve is accurate. If x is the click rate at the ceiling position and y is the click rate at the floor position, it can be seen that x+y=2*clicks. This equation can then be solved for x and y using the modeled changes in click rate between the floor and ceiling positions.

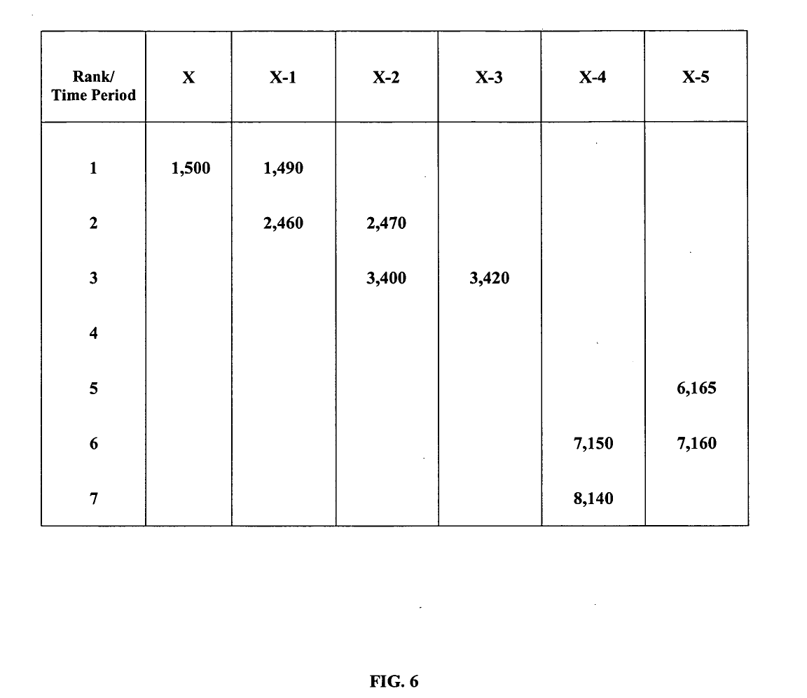

These calculated values can then be used to compute a two-dimensional matrix of historical data that shows the click rate only at integer positions for a single listing at each time slice. In the matrix in FIG. 6, for example, each column is a time slice with the most recent slice on the left side. The first value in each pair is position and the second value is the number of clicks in that time slice. It will be seen that in most cases, there will not be data for each integer position, and further that the relevance of the data will vary with age. In one aspect of the preferred embodiment, this two-dimensional matrix is collapsed into a one-dimensional array of data for the listing, with the first value in the-pair being the position and the second value in each pair being the number of clicks in a given time period.

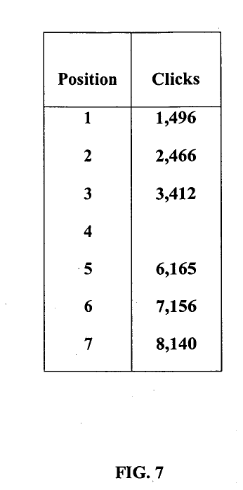

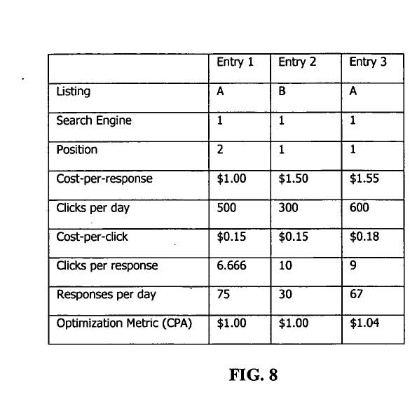

For example, the matrix in FIG. 6 can be condensed into the one-dimensional array shown in FIG. 7. The click model of the preferred embodiment accounts for the relevance of the available click data by assigning a weight for each value. One example of relevance might assume that older data is less relevant than more recent data, so older data should have a lower weight. Similarly, the click data can be weighted to account for the increased relevance of data from the same day of the week.

An example of a linear weighting mechanism based on age would weight the data such that if there are x time slices, the weight of the most recent data is x and the weight of the oldest data is 1. Every time slice gets a weight, even if it contains no data. In any subsequent averaging of multiple values, the weight of a particular value can be included by calculating a weighted average.

In order to condense the two-dimensional matrix of FIG. 6 into the one-dimensional array of FIG. 7, we must collect the average value at each position across all timeslices. The simplest technique for this is a mean average of all the data points for a given position. However, since it is possible to assign a relevance to any given data point, it may be more accurate to compute a weighted average which takes the relevance of each data point into account. A mean average would be calculated by summing the value at each data point and then dividing the sum by the number of data points. A weighted average multiplies the value at each data point by the weight before summing them. The sum is then divided by the sum of the weights instead of the number of data points. For example, the mean average of 2 and 3 is (2+3)/2=2.5. A weighted average, with the first data point having a weight of 2 and the second data point having a weight of 1, would be ((2*2)+(3*1)/(2+1) which is 2.333.

Thus, the two-dimensional matrix can be condensed into a one dimensional array as a weighted average for each position for which data is available. It should be noted that the cumulative weight of each position after calculating the average is retained for later use. For example, if the sum of the weights for position 1 was 35, then the value 35 is retained to assess the relevance of the computed weighted average.

To fill in the position gaps in the resulting one dimensional array and to force the average values computed per position to be in accordance with the normalized distribution, the preferred embodiment uses the normalized graph of change in click rate relative to position to calculate predicted values for the remaining positions. In the simplest example, the position with available data that is nearest the position to be calculated is multiplied by the change in click rate between the two positions to predict the click rate. For example, if there is a click rate for position 2 but not position 3, and the model indicates that position 3 receives 85% of the clicks of position 2, the model can simply multiply the value at position 2 by 0.85 to get a predicted click rate at position 3. Greater accuracy can be achieved if the model predicts the click rate for a position based on every known value, then averages the results to predict the value for the unknown position. It will be readily apparent to those skilled in the art that this model can be tuned using a variety of more complex weighting schemes.

Through this process, the click model of this preferred embodiment generates a predicted click rate for every possible position for that particular term/search engine combination. This process can then be repeated for every relevant term/search engine combination to generate a predictive click model for an entire campaign.

The present invention can also use a model that predicts the amount of “revenue” or the number of “revenue events” that will be generated by each consumer response to a listing, at each position, on each search engine, for a given time period. As used herein, “revenue” broadly refers not only to money changing hands, but also to other desired responses by consumers. For ease of reference, this model will be referred to as the “revenue model.”

For example, as described above, user responses can be traced using a standard web beacon well known in the art. By adding a dynamic variable to the system retrieval request for a 1×1 pixel, a web beacon can pass along information regarding the value of any transaction resulting from the consumer's response to the listing. Thus, it is possible to link actual revenue or the occurrence of a revenue event to the performance of a specific listing.

In a cost-per-response context, the amount of ‘revenue’ may be a count of the number of responses or revenue events. Alternatively, the value of the response could be included to generate an actual revenue-per-click metric. It can be seen to those skilled in the art that “revenue” can take virtually any form of derived value depending on the performance metric that is applied. Search advertising campaigns can thus be optimized to actual derived revenue or revenue events in any situation where revenue or revenue events can be tracked. Where a particular consumer can be linked to a response, either directly or anonymously by use of non-identifiable tracking tools, subsequent sales or other events can also be linked back to the initial response. This allows for the calculation of a lifetime value, including lifetime revenue, related to a particular response.

Finally, the present invention uses data reflecting the term landscape for particular term/search engine combinations. On many search engines, the term landscape indirectly indicates how much it costs to place a listing at a given position for a particular term on a particular search engine, since an advertiser would generally need to bid at least $0.01 over the current bid for that term in order to attain a given position. It should be noted that some search engines use different position ranking mechanisms that include price as only one of the factors that determines listing position.

The process of optimizing a search advertising campaign using the preferred embodiment will now be described using the inputs described above.

First, a term landscape entry is retrieved for every term/search engine combination, for every position in which a listing can be placed. Positions for which a bid value is not available are not included in the list, as such positions cannot be optimized. These term landscape entries are then sorted according to performance. As noted above, performance can be evaluated against any appropriate metric or combination of metrics. The most common metrics currently used are generally cost-per-response, cost-per-click, and campaign budget.

In a cost-per-response example, the predicted number of clicks in a given unit of time for each term/position/search engine combination can be retrieved from the click model. The bid landscape for that particular term provides a predicted cost-per-click for each position on each search engine. By multiplying this predicted cost-per-click by the predicted number of clicks for each term/position/search engine combination, the total cost for that term at each position on each search engine over the specified unit of time can be predicted.

The revenue model can then predict the number of revenue events that will be generated by each term/position/search engine combination during the specified unit of time by multiplying the predicted number of clicks by the predicted number of revenue events per click. The predicted cost-per-response can then be calculated by dividing the total cost for each term/position/search engine combination by the predicted number of revenue events.

The cost-per-response for each term/position/search engine combination for that unit of time can then be evaluated against all others. The determination of whether to include that listing in the set of ads that will be ‘placed’ can then be made based on other constraints placed on the campaign (maximum allowable cost-per-response, budget over time, maximum clicks per unit of time, etc).

Thus, using the revenue model, the click model, and the term landscape for each search engine, it is possible to optimize a campaign of listings across all search engines. In one preferred embodiment, every possible combination of listing, position and search engine for the campaign is assigned a “value.” In a cost-per-response context, this means calculating the predicted cost-per-response for each particular combination, then sorting by predicted cost-per-response, from lowest to highest. It will be understood by those skilled in the art that a variety of other mechanisms such as weighting factors can be used to achieve higher degrees of accuracy.

The system can also determine the available remaining budget and timeframe for the campaign. Using these three values (remaining budget, remaining time, and an entry which reflects the cost-per-response and the number of clicks per unit of time) the system can determine which listings at which positions to make active. For example, the entry with the lowest cost-per-response value will be first added to the active listings. It can then be determined how much that entry will cost over the remaining time for the campaign by multiplying the bid price by the predicted clicks over a unit of time, and then multiplying that number by the number of units of time left in the campaign.

The number of responses that will be obtained from that listing can also be determined using the revenue model data. If the total cost of the listing is less than the remaining budget, the total cost of the entry can be added to the amount spent on the campaign so far and the total responses for the entry can be added to the total number of responses for the campaign so far. The total expenditure can be divided by the total revenue to determine the average cost-per-response for the campaign. If the change in the average cost-per-response is desirable based on a campaign's metrics, that entry is valid and the next entry is evaluated. This process continues until the system has attained the target cost-per-response or exceeded some other constraint.

Some advertising campaigns will have a target range for cost-per-response as opposed to a specific target cost-per-response. The minimum cost-per-response establishes the minimum point to which the campaign must be optimized. The maximum cost-per-response is the point after which the campaign must be optimized down.

The preferred embodiment also checks to confirm that the system selects no more than the one preferred term landscape entry for a given search listing on a given search engine, as this is a restriction imposed by current search engines. Several methods are easily derived by those skilled in the art to determine which single term landscape entry to choose in the case where two term landscape entries have identical values as a function of the metric for which a given campaign is being optimized, and as such could be seen as equally desirable choices to optimize the performance of a given search listing. One example of how the system may select the desired term landscape entry is to select the search listing for the term landscape entry which predicts delivery of the highest quantity of clicks to the advertiser within the budget available for the campaign during the given period of time.

Finally, not all constraints are attained permanently. For example, the ratio of cost-per-response to expense changes from entry to entry. Thus, it is possible that one entry will exceed the remaining budget, but the next one will deliver a lower expense despite having a higher cost-per-response because the ratio of cost-per-response to expense is different. The only constraint which is guaranteed to be always increasing is the average cost-per-response itself, since the entries are being processed in order sorted on cost-per-response.

The optimization process of the preferred embodiment can be further illustrated by reference to the example of FIG. 8, which shows relevant data for three hypothetical term landscape entries, and the following assumptions regarding the associated advertising campaign:
Total Budget=$5200
Amount Spent to Date=$4950
Time left in Campaign=1 day
Total Responses to Date=4125
Target cost-per-response=$1.50
Average cost-per-response to Date=$1.20

Entry 1 is processed first since it has the lowest cost-per-response. In the specified time remaining for the campaign, Entry 1 will generate 500 clicks. This will have a total cost of $75.00 and result in 75 responses. Since it will increase the Amount Spent to Date to $5025 and the Total Responses to Date to 4200, Entry 1 will reduce the Average cost-per-response to $1.1964. For this example, Entry 1 is within budget, reduces the average cost-per-response, and will not cause the campaign to exceed its prescribed cost-per-response, so it is included in the campaign.

In this preferred embodiment, Entry 2 is processed next. In the specified time remaining for the campaign Entry 2 will generate 300 clicks. This will have a total cost of $45.00 and result in 30 responses. Since it will increase the Amount Spent to Date (inclusive of the predicted amount associated with Entry 1) to $5070 and the Total Responses to Date to 4230, Entry 2 will increase the Average cost-per-response slightly to $1.1985. For this example, Entry 2 is also within budget and below the prescribed cost-per-response, so it is included in the campaign.

Entry 3 is processed next. In the specified time remaining for the campaign Entry 3 will generate 600 clicks. This will have a total cost of $108.00 and result in 67 responses. However, since Entry 3 relates to the same listing on the same search engine as Entry 1, but in a different position, this preferred embodiment will first subtract the cost and number of responses relating to Entry 1. Thus the total expense if Entry 3 is included in the campaign is ($5070−$75)+$108=$5103. The total number of responses if included is (4230−75)+67=4222. This results in a new cost-per-response of $1.209.

Since Entry 3 actually increases cost-per-response and reduces the total number of responses, the preferred embodiment will include in the campaign only Entries 1 and 2, and will discard Entry 3. The system would therefore place bids for the listings and positions represented by Entries 1 and 2, and disable all other listings in the campaign. The optimization pass is now complete.

In another preferred embodiment, an advertising campaign can be controlled to spend the available budget as quickly as possible as long as it stays within other constraints on factors such as cost-per-response.

What is claimed is:

1. A method of search engine advertising, comprising:
selecting a metric for evaluating the performance of a search listing, and predicting the performance of said search term relative to said metric using a particular search term at a plurality of positions on a plurality of search engines, predicting the anticipated cost-per-response for each position, search engine combination, and
setting new bids or retaining old bids for listings based on said predictions.

2. The method of claim 1, wherein said performance is expressed as cost-per-click.

3. The method of claim 1, wherein said performance is expressed as cost-per-response.

4. A method of search engine advertising, comprising:
predicting the anticipated performance of a search term at a plurality of positions on a plurality of search engines;
sorting the results of said predictions of anticipated performance by a performance ranking.

5. A method of search engine advertising, comprising:
obtaining historical data about the number of responses that were received for a search listing at a first plurality of positions on a search engine;
using said historical data to predict the number of responses that will be received for said search listing at a second plurality of positions on a search engine.

6. The method of claim 5, wherein said historical data is obtained from the search engines.

7. The method of claim 5, wherein said second plurality of positions includes positions for which no historical data is available.

8. The method of claim 5, wherein said historical data is acquired via electronic transfer.

9. The method of claim 5, wherein said prediction is derived by mapping said historical data against a general predicted distribution.

10. The method of claim 9, wherein said general predicted distribution is a distribution normalized between 0 and 1 for each of a plurality of positions.

11. The method of claim 10, wherein said historical data is mapped by assuming that the n most heavily weighted data points are on said normalized distribution.

12. The method of claim 5, wherein said historical data about the number of responses includes average position information aggregated over a unit of time.

13. The method of claim 5, wherein said historical data about the number of responses includes the actual number of clicks per position.

14. The method of claim 5, wherein said historical data about the number of responses is weighted based on the time it was generated.

15. The method of claim 5, wherein each position is assigned a relevance score for ranking the relevance of said historical data to said position.

16. The method of claim 5, further comprising:
predicting the number of responses for said first plurality of positions by averaging the available historical data.

17. The method of claim 5, further comprising:
repeating these steps for a plurality of search engines.

18. The method of claim 5, further comprising:
predicting the rate of response at every relevant position on every relevant search engine.

19. A method of search engine advertising, comprising:
obtaining historical data about the rate of responses as a function of the number of responses that were received for a search listing at a first plurality of positions on a search engine;
using said historical data to predict the rate of responses as a function of the number of responses that will be received for said search listing at a second plurality of positions on a search engine.

20. The method of claim 19, wherein said historical data is obtained from the search engines.

21. The method of claim 19, wherein said second plurality of positions includes positions for which no historical data is available.

22. The method of claim 19, wherein said historical data is acquired via electronic transfer.

23. The method of claim 19, wherein said prediction is derived by mapping said historical data against a general predicted distribution.

24. The method of claim 23, wherein said general predicted distribution is a distribution normalized between 0 and 1 for each of a plurality of positions.

25. The method of claim 19, wherein said average position information is modified to allocate the time spent at actual positions.

26. The method of claim 19, wherein each position is assigned a relevance score for ranking the relevance of said historical data to said position.

27. The method of claim 24, wherein said historical data is mapped by assuming that the n most heavily weighted data points are on said normalized distribution.

28. The method of claim 19, further comprising:
predicting the number of responses for said first plurality of positions by averaging the available historical data.

29. The method of claim 19, further comprising:
repeating these steps for a plurality of search engines.

30. The method of claim 19, further comprising:
predicting the rate of response at every relevant position on every relevant search engine.

31. A method of search engine advertising, comprising:
determining a term landscape entry for each of a plurality of terms; and
calculating an optimization value for each said term landscape entry using the predicted number of responses and predicted revenue rate.

32. The method of claim 31, further comprising:
sorting said term landscape entries by optimization value.

33. The method of claim 31, further comprising:
validating said term landscape entries within at least the constraints of (a) target optimization value; (b) time remaining in a relevant advertising campaign; and (c) budget remaining for said advertising campaign.

34. The method of claim 31, further comprising:
selecting at least one term landscape entry based on said optimization values.

35. The method of claim 34, further comprising:
setting a bid on a search engine for each said selected term landscape entry.
